(19) United States
(12) Patent Application Publication
(10) Pub. No.: US 2009/0151647 A1
(43) Pub. Date: Jun. 18, 2009

(54) Inflatable, multi-purpose whelping system, and method and kit for preparing same

(76) Inventor: Brenda L. Burrows, Clinton Twp., MI (US)

Correspondence Address: Brenda L. Burrows, 20738 S. Miles, CLINTON TWP, MI, 48036, US

(21) Appl. No.: 12/315,242

(22) Filed: Dec. 2, 2008

Related U.S. Application Data
(60) Provisional application No. 61/007,355, filed on Dec. 13, 2007.

(51) Int. Cl. A01K 1/00; A01K 1/03

(52) U.S. Cl. 119/513; 119/515

(57) ABSTRACT

An inflatable, multi-purpose whelping system has an inflatable pen with an inflatable, peripheral side wall attached to a bottom. A liner that drapes the interior surfaces of the inflatable pen is fastened to the pen. The inflatable, peripheral side wall comprises a plurality of discretely inflatable segments disposed one atop another to allow for height-adjustment of the inflatable, peripheral side wall. The liner has a band biasing a peripheral portion of the liner into a wall seam between adjacent segments of the inflatable, peripheral side wall. The inflatable, multi-purpose whelping system includes a feeder. A method and a kit for preparing the inflatable multi-purpose whelping system are also disclosed.

### BACKGROUND OF THE INVENTION

There are a variety of animal enclosures designed for the general containment of pets and/or pet waste. Some enclosures are designed primarily as litters, to contain pet waste prior to disposal. Other enclosures are designed primarily as pens, to provide a protected space for pets. Pens designed primarily for the purpose of providing a secure enclosure for female animals to give birth and raise their young are often referred to as whelping pens. For example, U.S. Published Pat. Application No. 2003/0024483 (Pederson) discloses a whelping pen and U.S. Pat. No. 5,497,729 (Lord) discloses a whelping box. Similarly, a pet enclosure that can be used for whelping purposes is disclosed in U.S. Pat. No. 6,513,456 (Sherman).

Animal pens designed for general containment or whelping purposes that are constructed of hard-frame materials or a combination of hard and soft-frame materials are already known. For example, U.S. Pat. No. 6,354,245 (Roddy) discloses a six-sided pet cage where the top and bottom sides are rigid and the wall sides are inflatable. A hard-framed pet enclosure that can be used for whelping purposes is disclosed in U.S. Pat. No. 6,513,456 (Sherman). Some of these pens are designed for self-assembly and/or are collapsible. For instance, U.S. Pat. No. 5,497,729 (Lord) discloses a collapsible whelping box and U.S. Pat. No. 6,354,245 (Roddy) discloses a collapsible pet cage. A whelping pen that is self-assembling, collapsible and disposable is disclosed in U.S. Published Pat. Application No. 2003/0024483 (Pederson). There are yet other pen designs intended for children. Play pens for children that are constructed of soft-frame and inflatable materials are already known. For example, U.S. Pat. No. 4,815,153 (Bleser) discloses a child's play pen having an inflatable mattress portion, upper and lower tube portions, and wall column portions with interconnected netting. Similarly, a child's play pen having an inflatable tube base and upper tube railing connected by flexible column portions is disclosed in U.S. Pat. No. 3,430,271 (Junot-Deile).

There are whelping pens constructed with an opening for the mother to enter and leave the pen. Other designs provide an opening that is adjustable so as to alter the height of the opening from one fixed position to another, in an effort to restrict the exit of whelps that outgrow the smaller opening. Such a construction is disclosed in U.S. Pat. No. 5,497,729 (Lord) wherein a whelping box has a gate for entry and exit by the mother. Similarly, U.S. Pat. No. 6,513,456 (Sherman) discloses an elevation-type gate for entry and exit by the mother and a whelping pen with a raised-door aperture is disclosed in U.S. Published Pat. Application No. 2003/0024483 (Pederson). In addition, cages designed for pets have also been adapted with gates, as disclosed in U.S. Pat. No. 6,354,245 (Roddy) showing a pet cage with an opening for pet entry and exit.

There are animal pens outfitted with liners for covering the walls and inside floor of the pen. For example, U.S. Published Pat. Application No. 2003/0024483 (Pederson) discloses a whelping pen with a disposable covering that lines the insides of the pen and drapes along the outside walls temporarily secured along the top edges of the walls by fasteners. Similarly, a pet pen having a removable and washable covering, or liner cloth, is disclosed in U.S. Pat. No. 6,513,456 (Sherman). The liners, some of which are disposable, are generally intended for the collection of waste. While liners may provide general waste containment, residual waste may reach the pen itself, either during removal or replacement of a liner or any time the pen itself may become exposed to waste. For this reason, there are pens that are chemically treated to resist moisture, or, are themselves disposable, i.e., intended for disposal after such use. For example, U.S. Published Pat. Application No. 2003/0024483 (Pederson) discloses a disposable whelping pen constructed of material impregnated with a moisture resistant chemical to prevent absorption of urine.

Conventional whelping pens limit the range of activities in which a nursing mother can engage while inside the pen. For example, when it is time for a mother to feed herself, she must leave her young behind in a conventional pen to prevent her whelps from coming in contact with foods or liquids otherwise intended for the mother. Floor-based animal feeders that are adjustable in height are already known. They are primarily designed to address the feeding needs of animals of various sizes and heights. For instance, U.S. Design Pat. No. D414, 303 (Sharon) discloses an elevated pet feeder and an adjustable height pet feeder is disclosed in U.S. Pat. No. 6,854,419 (Tsengas). These animal feeders, however, do not address the problems encountered in the whelping environment where there is a need to restrict whelps from accessing the feeder and its contents.

While advances in whelping pen design have attempted to provide enhanced conveniences for pet owners and breeders these advances have not been satisfactory. Accordingly, there is a need for a multi-purpose whelping system, method and kit that delivers the benefits of easy assembly, efficient storage and convenient, effective waste removal within a secure, comfortable, pet-friendly, and humane environment, particularly one that is suitable for raising, training and otherwise accommodating the needs of a mother and her young.

### SUMMARY OF THE INVENTION

Aspects of the present invention address these issues and others by providing an inflatable, multi-purpose whelping system and a method of, and kit for, preparing said system.

In one aspect, the present invention provides a system that comprises a pen constructed of soft, flexible material, a peripheral side wall of which is inflatable. The inflatable, peripheral side wall is preferably height-adjustable. The inflatable, peripheral side wall provides a cushioned perimeter, eliminating any discomfort or injury that can arise when an animal engages with a conventional pen, particularly upon entry and egress. Thus, the inflatable, multi-purpose whelping system of the current invention accommodates the comfortable and easy entry and exit of small, medium and large breed mothers while restricting the exit of their respective young. In addition, the uninflated pen folds for easy and efficient storage.

The system of the present invention further comprises a liner which is disposed to securely attach to the pen. The liner is preferably disposable. Another feature of the system includes a means of fastening the liner to the pen. Preferably, the means of fastening the liner to the pen is a band which binds the liner to the pen along the outer surface of the inflatable, peripheral side wall. In the preferred embodiment, the soft, flexible material is smooth and non-absorbent, thus providing a ready solution for any inadvertent contact with waste and for easy clean-up.

The system of the present invention may include a feeder. Preferably, the feeder is one which attaches to the inflatable, peripheral side wall and includes a feeder bowl disposed inside the pen. Optionally, the feeder contains a plurality of feeder bowls. The feeder allows the nursing mother to remain with her young while she feeds herself.

Another aspect of the present invention is a method of preparing the system. This aspect includes obtaining an inflatable pen with an inflatable peripheral side wall, a liner and a fastening means. The method further comprises inflating the pen and draping and fastening the liner to the pen. A preferred feature of this aspect includes obtaining a feeder having a feeder bowl and suspending the feeder bowl inside the pen. The feeder preferably attaches to the inflatable, peripheral side wall and preferably includes separate bowls for food and water. The pen may be obtained simply by purchasing an inflatable swimming pool for children.

Still another aspect of the present invention is a kit for preparing the system of the present invention. This includes an inflatable pen, a liner, and a means of fastening the liner to the inflatable, pen. The kit may include a plurality of replacement liners, preferably a plurality of disposable replacement liners. The kit may include a feeder, preferably a feeder that is adapted for attachment to an inflatable, peripheral side wall of the inflated pen.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is an exploded view of a kit for preparing an inflatable, multi-purpose whelping system showing an un-inflated and folded inflatable swimming pool, a liner, and components of a feeder.

FIG. 2 is a perspective view of an inflatable, multi-purpose whelping system showing an inflated inflatable pen with a liner and an attached feeder.

FIG. 3 is a vertical cross-sectional view of an inflatable, peripheral side wall of the inflatable pen and liner, the inflatable, peripheral side wall having discretely inflatable segments fixedly disposed one atop another and the liner biasing against a wall-seam of the inflatable, peripheral side wall between adjacent segments.

FIG. 4 is a vertical cross-sectional view of the inflatable, peripheral side wall showing discretely inflatable segments disposed for height-adjustment of the inflatable, peripheral side wall.

FIG. 5 is a vertical cross-sectional view of the preferred embodiment of the feeder of the present invention.

FIG. 6 a vertical cross-sectional view of the preferred embodiment of the feeder of the present invention in collapsed form.

FIG. 7 is a top view of the preferred embodiment of a feeder holder of the present invention.

FIG. 8 is a top view of the inflatable pen having a generally circular configuration.

FIG. 9 is a top view of the inflatable pen having a generally square configuration.

FIG. 10 is a top view of the inflatable pen having a generally triangular configuration.

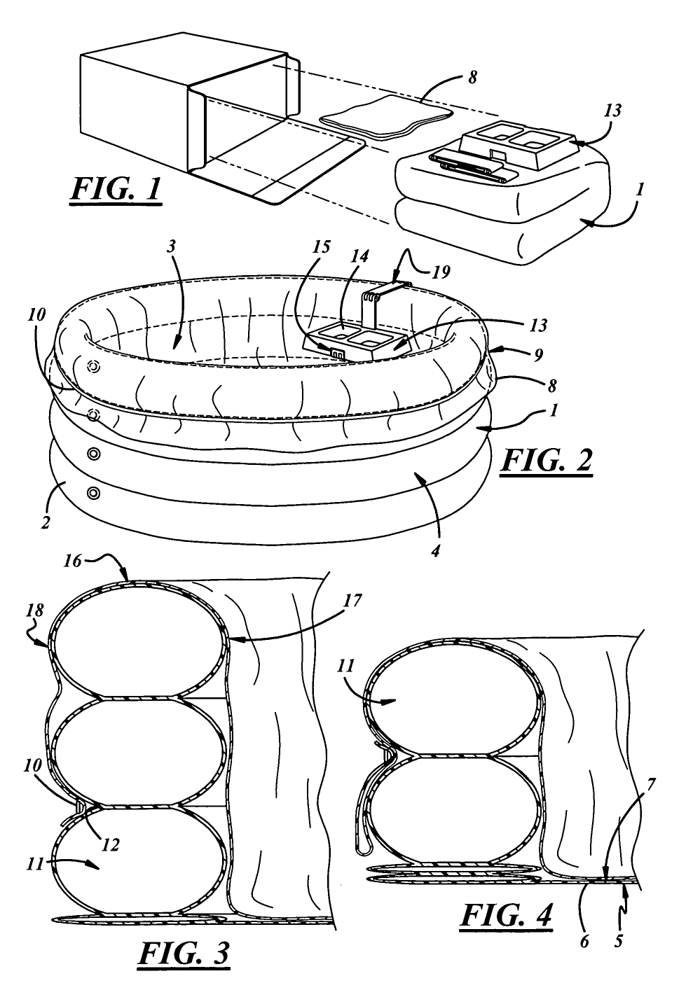

### DETAILED DESCRIPTION OF THE PREFERRED EMBODIMENTS

The inflatable, multi-purpose whelping system of the present invention, shown generally in FIG. 2, comprises an inflatable pen (1) having an inflatable, peripheral side wall (2) and a bottom (5), the bottom (5) being attached to the inflatable peripheral side wall (2). Preferably, the inflatable pen (1) is constructed of water-resistant material allowing for easy clean-up should any liquid, food or waste come in contact with the pen (1) itself. The inflatable, peripheral side wall (2) has an interior surface (3) and an exterior surface (4), and the bottom (5) has an interior surface (6) and an exterior surface (7). The multi-purpose whelping system of the present invention includes a liner (8), primarily to protect the pen (1) from direct contact with waste and to temporarily contain waste prior to its removal. The liner (8) is disposed to drape the interior surface (6) of the bottom (5), the interior surface (3) of the inflatable, peripheral side wall (2), and a predetermined length of the exterior surface (4) of the side wall (2). The multi-purpose whelping system of the present invention further comprises a means of fastening the liner (8) to the inflatable pen (1).

Preferably, the system includes a liner (8) having a peripheral portion (9) which engages with the exterior surface (4) of the inflatable, peripheral side wall (2). Herewith, the means of fastening the liner (8) to the inflatable pen (1) is a band (10), wherein the band (10) biases the peripheral portion (9) of the liner (8) against the exterior surface (4) of the inflatable, peripheral side wall (2). The band (10) provides a means of fastening the liner (8) to the pen (1) so as to resist displacement of the liner (8).

The inflatable, peripheral side wall (2), as shown in FIGS. 3, and 4, preferably comprises a plurality of discretely inflatable segments (11) fixedly disposed one atop another. The discretely inflatable segments (11) provide for height-adjustment of the inflatable, peripheral side wall (2) by allowing for the selective inflation of one or more segments (11) as desired depending upon the size of the animal breed. Herewith, the inflatable, peripheral side wall (2) has a wall seam (12) between adjacent segments (11). The band (10) biasing the peripheral portion (9) of the liner (8) securely engages the liner (8) to the inflatable peripheral side wall (2) at the wall seam (12).

Optionally, the system further comprises a feeder (13), as shown generally in FIG. 2. Preferably, the feeder (13) comprises a feeder bowl (14) and a hanging feeder holder (15), as shown in FIGS. 2, 5 and 6. Herewith, the hanging feeder holder (15) is dimensioned to securely receive the feeder bowl (14) disposed within the hanging feeder holder (15). The inflatable, peripheral side wall (2) of the pen (1) generally comprises a top portion (16) coextensive with an interior side portion (17), the top portion (16) also coextensive with an exterior side portion (18). The preferred feeder (13) comprises a hanging feeder arm (19) which is coextensive with the hanging feeder holder (15) and dimensioned to generally contour the exterior side portion (18), the top portion (16) and the interior side portion (17) of the inflatable, peripheral side wall (2) for flexible engagement and secure attachment thereupon. Optionally, the feeder (13) of the system of the present invention has a plurality of feeder bowls (14) as shown in FIG. 7 to simultaneously provide a variety of nutritional supplements such as food, water, milk, special formulas and the like.

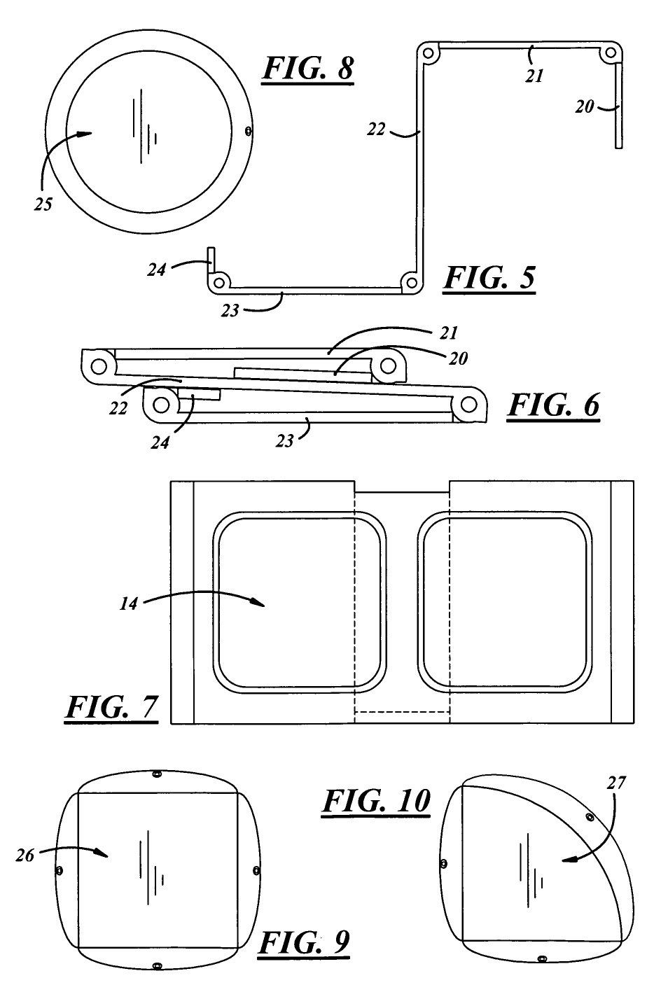

Preferably, the system includes a collapsible feeder (13), as shown in FIGS. 5 and 6. Herewith, the hanging feeder arm (19) has an outer portion (20) a cover portion (21) and an inner portion (22). The outer portion (20) is pivotally connected to the cover portion (21) and the cover portion (21) is pivotally connected to the inner portion (22). The hanging feeder holder (15) has an engagement portion (23) and a lip (24). The lip (24) is pivotally connected to the engagement portion (23) and the engagement portion (23) is pivotally connected to the inner portion (22) of the hanging feeder arm (19). The preferred feeder (13) is thus fully collapsible, as shown in FIG. 6, is easily and quickly folded for storage in an efficient spatial arrangement, and is readily assembled for reuse.

The inflatable pen (1) is shown in FIG. 8 as having a generally circular configuration (25). Optionally, the configuration of the inflatable pen (1) comprises a plurality of predetermined angles. Herewith, the inflatable pen (1) has a generally square configuration (26), as shown in FIG. 9 and a generally triangular configuration (27), as shown in FIG. 10. This allows for customization of the system in accordance with individual space and design considerations.

One aspect of the present invention is a method for preparing an inflatable multi-purpose whelping system. The method comprises obtaining an inflatable pen (1) having an inflatable, peripheral side wall (2) and a bottom (5), the inflatable, peripheral side wall (2) having an interior surface (3) and exterior surface (4) and the bottom (5) having an interior surface (6) and an exterior surface (7). The method further comprises inflating the inflatable, peripheral side wall (2) so as to provide an inflated, peripheral side wall (2) of increased height and to stretch the bottom (5) of the pen to its full dimension. Preferably, the method comprises obtaining an inflatable pen (1) that is a child's swimming pool. The method also comprises obtaining a liner (8) and draping the liner along the interior surface (6) of the bottom (5) and along the interior surface (3) of the inflated, peripheral side wall (2), and draping the liner (8) along a predetermined length of the exterior surface (4) of the inflated peripheral side wall (2). The method further comprises obtaining a means of fastening the liner (8) to the inflatable pen (1). Optionally, the method includes obtaining a liner (8) that is disposable and is replaced by a fresh disposable liner (8). Preferably, the method of preparing the system comprises the steps of obtaining a feeder (13) having a feeder bowl (14) and situating the feeder bowl (14) inside the inflated pen (1). Optionally, the feeder bowl (14) is situated inside the inflated pen by attaching the feeder (13) to the inflated, peripheral side wall (2).

Another aspect of the present invention is a kit for preparing an inflatable, multi-purpose whelping system. The kit comprises an inflatable pen (1), a liner (8) for lining the inflatable pen (1), and a means of fastening the liner (8) to the inflatable pen (1). Optionally, the kit comprises a plurality of replacement liners (8). Preferably, the plurality of replacement liners (8) is disposable. The kit for preparing the system preferably includes a feeder (13). Optionally, the feeder (13) is adapted for attachment to an inflated, peripheral side wall (2) of the inflatable pen (1). In the preferred embodiment, the inflatable pen (1) is a child's swimming pool.

While the best modes for carrying out the invention have been described in detail, those familiar with the art to which this invention relates will recognize various alternative designs and embodiments for practicing the invention within the scope of the appended claims.

What is claimed is:

1. An inflatable multi-purpose whelping system comprising:
an inflatable pen (1) having an inflatable, peripheral side wall (2) and a bottom (5);
the inflatable, peripheral side wall (2) having an interior surface (3) and an exterior surface (4);
the bottom (5), being attached to the inflatable, peripheral side wall (2) and having an interior surface (6) and an exterior surface (7);
a liner (8) disposed to drape the interior surface (6) of the bottom (3), the interior surface (3) of the inflatable, peripheral side wall (2) and a predetermined length of the exterior surface (4) of the side wall (2); and
a means of fastening the liner (8) to the inflatable pen (1).

2. An inflatable multi-purpose whelping system as defined in claim 1 wherein the inflatable peripheral side wall (2) further comprises:
a plurality of discretely inflatable, segments (11) fixedly disposed one atop another for height-adjustment of the inflatable, peripheral side wall (2).

3. An inflatable multi-purpose whelping system as defined in claim 1 wherein:
the liner (8) has a peripheral portion (9) engaging the exterior surface (4) of the inflatable, peripheral side wall (2) and wherein the means of fastening the liner (8) to the inflatable pen (1) includes a band (10) biasing the peripheral portion (9) of the liner (8) against the exterior surface (4) of the inflatable, peripheral side wall (2).

4. An inflatable multi-purpose whelping system wherein the inflatable, peripheral side wall (2) has a plurality of discretely inflatable segments (11) fixedly disposed one atop another for height-adjustment of the inflatable, peripheral side wall (2) and a wall seam (12) between adjacent segments (11) and wherein the band (10) biases the peripheral portion (9) of the liner (8) into the wall seam (12) of the inflatable, peripheral side wall (2).

5. An inflatable multi-purpose whelping system as defined in claim 3 wherein the liner (8) is disposable.

6. An inflatable multi-purpose whelping system as defined in claim 5 further comprising a feeder (13).

7. An inflatable multi-purpose whelping system as defined in claim 6 wherein the feeder (13) further comprises:
a feeder bowl (14);
a hanging feeder holder (15) dimensioned to receive the feeder bowl (14), the feeder bowl (14) nesting within the hanging feeder holder (15);
a top portion (16) of the inflatable, peripheral side wall (2);
an interior side portion (17) of the inflatable, peripheral side wall (2);
an exterior side portion (18) of the inflatable, peripheral side wall (2), the interior side portion (17) of the inflatable, peripheral side wall (2) coextensive with the top portion (16) of the inflatable, peripheral side wall (2) and the top portion (16) of the inflatable, peripheral side wall (2) coextensive with the exterior portion (22) of the inflatable, peripheral side wall (2);
a hanging feeder arm (19) coextensive with the handing feeder holder (15); the hanging feeder arm (19) dimensioned to generally contour the exterior side portion (18), the top portion (16), and the interior side portion (17) of the inflatable, peripheral side wall (2) and to flexibly inter-engage and securely attach thereupon.

8. An inflatable multi-purpose whelping system as defined in claim 7 wherein the feeder has a plurality of feeder bowls (14).

9. An inflatable multi-purpose whelping system as defined in claim 1 wherein the inflatable pen (1) has a generally circular configuration (25).

10. An inflatable multi-purpose whelping system as defined in claim 1 wherein the inflatable pen (1) has a generally square configuration (26).

11. An inflatable multi-purpose whelping system as defined in claim 1 wherein the inflatable pen (1) has a generally triangular configuration (27).

12. A method of preparing an inflatable multi-purpose whelping system comprising the steps of:
obtaining an inflatable pen having an inflatable, peripheral side wall and a bottom, the peripheral side wall having an interior surface and an exterior surface and the bottom having an interior surface and an exterior surface;
inflating the inflatable, peripheral side wall to provide an inflatable, peripheral side wall of increased height and to stretch the bottom to its full dimension;
obtaining a liner;
draping the interior surface of the bottom and the interior surface of the inflatable, peripheral side wall with the liner;
draping the liner along a predetermined length of the exterior surface of the inflatable, peripheral side wall;
obtaining a fastening means; and
securing the liner to the pen with the fastening means.

13. The method of preparing an inflatable multi-purpose whelping system as defined in claim 12 wherein the liner is disposable and replaced by a fresh disposable liner.

14. The method of preparing an inflatable multi-purpose whelping system as defined in claim 12 further comprising the steps of:
obtaining a feeder having a feeder bowl; and
disposing the feeder bowl inside the inflated pen.

15. The method of preparing an inflatable multi-purpose whelping system as defined in claim 14 wherein the feeder bowl is disposed inside the inflated pen by attaching the feeder to the inflated, peripheral side wall.

16. The method of preparing an inflatable multi-purpose whelping system as defined in claim 14 wherein the feeder has a plurality of feeder bowls.

17. The method of preparing an inflatable multi-purpose whelping system as defined in claim 12 wherein the inflatable pen is a swimming pool.

18. A kit for preparing an inflatable multi-purpose whelping system comprising:
an inflatable pen;
a liner for lining the inflatable pen; and
a means of fastening the liner to the inflatable pen.

19. A kit for preparing an inflatable multi-purpose whelping system kit as described in claim 18 further comprising:
a plurality of replacement liners.

20. A kit for preparing an inflatable multi-purpose whelping system as described in claim 19 wherein the liner and the plurality of replacement liners are disposable.

21. A kit for preparing an inflatable multi-purpose whelping system as described in claim 18 further comprising a feeder.

22. A kit for preparing an inflatable multi-purpose whelping system as described in claim 21 wherein the feeder is adapted for attachment to an inflated peripheral side wall of the inflatable pen.

23. A kit for preparing an inflatable multi-purpose whelping system as described in claim 17 wherein the inflatable pen is an inflatable swimming pool.
